(19) United States
(12) Patent Application Publication
(10) Pub. No.: US 2011/0128829 A1
(43) Pub. Date: Jun. 2, 2011

(54) Optical Recording Head And Optical Recording Apparatus

(76) Inventors: Naoki Nishida, Shiga (JP); Hiroaki Ueda, Osaka (JP); Hiroshi Oshitani, Hyogo (JP); Manami Kuiseko, Kyoto (JP); Koujirou Sekine, Osaka (JP); Hiroshi Hatano, Osaka (JP); Kou Osawa, Hyogo (JP)

(21) Appl. No.: 13/054,995

(22) PCT Filed: Jul. 6, 2009
(86) PCT No.: PCT/JP2009/062285

§ 371 Date: Jan. 20, 2011

(30) Foreign Application Priority Data
Jul. 24, 2008 (JP) 2008-190828

(51) Int. Cl. G11B 7/135; G11B 13/04

(52) U.S. Cl. 369/13.32; 369/112.28; 369/112.05; G9B/13.003; G9B/7.112

(57) ABSTRACT

An optical recording head to record information onto a recording medium utilizing light including; a slider provided to move relatively to the recording medium; a light propagation element provided on a side surface of the slider substantially vertical against a recording surface of the recording medium so as to cause propagation of light incident with a predetermined angle to be irradiated on the recording medium; and, a prism provided on the light propagation element so as to oppose to the side surface of the slider having the light propagation element and to deflect the incident light to be incident into the light propagation element with a predetermined angle.

### TECHNICAL FIELD

The present invention relates to an optical recording head and an optical recording apparatus.

### BACKGROUND

In recent years, higher density of an information recording medium is required and various recording methods have been proposed. One of them is a thermally assisted magnetic recording method. It is necessary to make the size of an individual magnetic domain small to achieve higher density in a magnetic recording method, while a recording medium comprising a material having large coercive force is required to stably keep data. In such a recording medium, it is necessary to generate a strong magnetic field for writing, however, the magnetic field of a small head corresponding to a magnetic domain having been made small has a limit.

Therefore, in a thermally assisted magnetic recording method, magnetic softening is caused with local heating of a recording medium at the time of recording and recording is performed in a state of a small coercive force, followed by stop of heating to allow natural cooling, whereby stability of a magnetic bit having been recorded is assured.

In a thermally assisted magnetic recording method, it is desirable to perform heating of a recording medium instantaneously. Further, contact of a heating mechanism with a recording medium is not allowed. Therefore, heating is generally performed utilizing light absorption, and a method utilizing light for heating is referred to as an optically assisted method. In the case of performing high density recording by means of optically assisted method, a minute optical spot having a diameter of not more than the wavelength of utilized light is required.

Therefore, proposed is an optical head which utilizes evanescent field light (also referred to as near viewing field light) generated from an optical opening having a size of not more than a wavelength of incident light (confer patent document 1).

An optical recording head described in patent document 1 is equipped with a magnetic pole for writing and a waveguide path provided with a core layer and a cladding layer adjacent to said magnetic pole for writing. In a core layer, a diffraction grating to introduce light into said core layer is provided. When such as laser light is irradiated against this diffraction grating, laser light is coupled to a core layer. Light coupled to a core layer converges on a focus locating in the neighborhood of the top portion of a core layer, a recording medium being heated by light irradiated from the top portion, and writing is performed by a magnetic pole for writing. The element provided with a waveguide having a condense function is called as a waveguide type solid immersion mirror (PSIM: Planer Solid Immersion Mirror), and a PSIM described in patent document 1 is equipped with a diffraction grating. In consideration of a ratio of light quantity (efficiency of light utilization) condensed with a PSIM against light quantity incident on the diffraction grating, there is a proper angle as the incident angle of light into a diffraction grating.

### PRIOR ARTS

### Patent Document

Patent document 1: U.S. Pat. No. 6,944,112

### SUMMARY OF THE INVENTION

### Problems to be Solved by the Invention

However, in patent document 1, there is only description to irradiate light from a light source simply being inclined against a diffraction grating and there is no description about a specific procedure to guide light from a light source into a diffraction grating.

This invention has been made in view of the above-described problem, and the object is to provide a light introduction technology which enables increased light utilization efficiency in an optical recording head and an optical recording apparatus.

### Means to Solve the Problems

The above-described problems can be solved by the following constitutions.

1. An optical recording head to record information onto a recording medium utilizing light including, a slider provided to move relatively to the recording medium, a light propagation element provided on a side surface of the slider substantially vertical against a recording surface of the recording medium so as to cause propagation of light incident with a predetermined angle to be irradiated on the recording medium, and, a prism provided on the light propagation element so as to oppose to the side surface of the slider having the light propagation element and to deflect the incident light to be incident into the light propagation element with a predetermined angle.

2. The optical recording head described in the aforesaid item 1, wherein the light propagation element further including, a waveguide to propagate light, and a diffraction grating to cause optical coupling of a light incident with a predetermined angle onto the waveguide.

3. The optical recording head described in the aforesaid item 2, wherein the waveguide is provided with a function to converge a propagating light.

4. The optical recording head described in any one of the aforesaid items 1-3, wherein the prism is provided with a diffraction grating, and, the diffraction grating is provided parallel to the side surface of the slider on which the prism is provided via the light propagation element.

5. The optical recording head described in the aforesaid item 4, wherein a thermal expansion coefficient of a material constituting the slider is smaller than a thermal expansion coefficient of a material constituting the prism.

6. The optical recording head described in the aforesaid item 5, wherein a material of the slider is ceramic and a material of the prism is resin.

7. The optical recording head described in any one of the aforesaid items 1-6, wherein the prism is provided so as to cover a whole surface on which the light from the light propagation element is incident.

8. An optical recording apparatus including the optical recording head described in any one of the aforesaid items 1-7, a light source to emit light to be incident on the aforesaid prism and a recording medium on which information is recorded utilizing light from the aforesaid light propagation element.

9. The optical recording apparatus described in the aforesaid item 8 wherein the recording medium is a magnetic recording medium, and, the optical recording head is provided with a magnetic recording part to perform magnetic recording on the magnetic recording medium.

### Effects of the Invention

According to an optical head and an optical recording apparatus of this invention, utilization efficiency of light can be improved.

### BRIEF DESCRIPTION OF THE DRAWINGS

FIG. 1 is a drawing to show an outline constitution of an optical recording apparatus mounted with an optically assisted magnetic recording head in an embodiment of this invention.

FIG. 2 is a drawing to show an outline constitution of an optical recording head.

FIG. 3 is a front view of a light propagation element.

FIG. 4 is a cross-sectional view of a light propagation element.

FIG. 5 is a front view of another example of a light propagation element.

FIG. 6 is a drawing to show the first specific example of a prism.

FIG. 7 is a drawing to show the second specific example of a prism.

FIG. 8 is a drawing to show the third specific example of a prism.

FIG. 9 is a drawing to show the fourth specific example of a prism.

FIG. 10 is a drawing to show the deformation of a prism due to temperature variation.

FIG. 11 is a drawing to show another example of an outline constitution of an optical recording head.

FIG. 12 is a drawing to show an example of a plasmon antenna.

FIG. 13 is a drawing to show an example of a manufacturing method for providing a slider equipped with an optical propagation element with a prism.

FIG. 14 is a drawing to show an outline constitution of an optical recording head according to a reference example.

### PREFERRED EMBODIMENT OF THE INVENTION

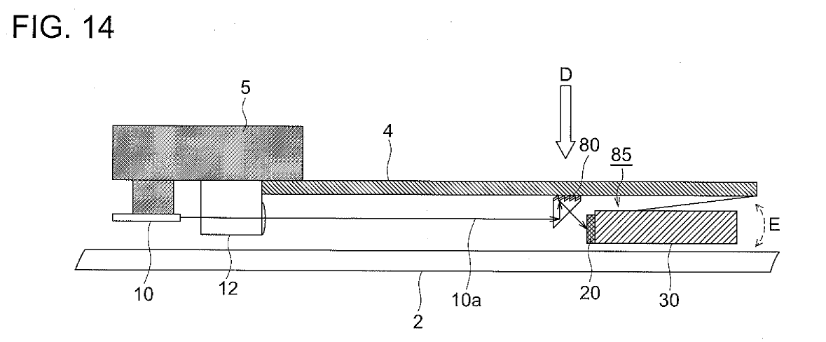

First, before explanation of an embodiment of this invention, a reference example will be explained in reference to FIG. 14.

FIG. 14 is a drawing to show an outline constitution of an optical recording head and the neighboring portion in a reference example.

In FIG. 14, 2 is a recording medium, 4 is a suspension supported by arm 5 which is arranged rotatably toward the tracking direction, and 85 is an optical head attached on the top of suspension 4. Light source 10 such as an optical fiber and lens 12 are fixed on atm 5 and light from light source 10 is emitted as parallel light through lens 12.

Optical head 85 is provided with slider 30 relatively shifts against disc 2 which is a recording medium, and light propagation element 20 such as PSIM to make light 10a from light source 10 propagate to disc 2 is arranged on the side surface of slider 30. Light 10a is irradiated approximately from the side direction against slider 30 which is provided with light propagation element 20. The gap from disc 2 in the vertical direction (the vertical direction against the surface of disc 2) to suspension 4 is very narrow such as approximately 0.5 mm.

It is necessary to make the incident angle of light incident into light propagation element 20 optimum to efficiently propagate light 10a into disc 2, and prism 80 is arranged on a light path of light 10a to deflect light 10a to be incident into light propagation element 20 with an optimum angle.

Prism 80 is fixed on suspension 4 in this reference example. Suspension 4 causes bending in the vicinity shown by symbol D at the time of pressing slider 30 against disc 2 by the spring action. In the case that stress caused by this bending acts on prism 80, double refraction is caused which possibly affects optical characteristics such as polarization rotation. Thereby stability of evanescent field light generated at the light emitting top of light propagation element 20 is affected to cause a fear of disabling stable recording on a recording medium.

Further, slider 30 is held on suspension 4 so as to finely vary the inclination relative to the direction E shown in FIG. 14 depending on a minute undulation of the surface of disc 2. It is not easy to assemble prism 80 on suspension 4 with a good precision so as to make light 10a to be incident into light propagation element 20 of slider 30, which is held in the above state, with a highly precise incident angle.

Further, during operation, it is naturally expected that a relative angle between prism 80 and slider 30 delicately varies. The delicate relative angle change, in the case of preparing an optical head having higher stability or an optical recording apparatus combining the same, there is a fear to cause a problem of such as decrease of light propagation efficiency.

Also in the optical recording head of this reference example, there causes no problem when an ideal state is prepared; however, it is considered that there still is a problem with respect to easiness of assembly and stability of recording on a recording medium.

In the embodiment of this invention which will be explained in the following, such problems in the reference example can be solved.

In the following, an optically assisted magnetic recording head which is an embodiment of this invention, and an optical recording apparatus equipped with said head will be explained; however, this invention is not limited to this embodiment. Herein, same parts or corresponding parts in each embodiment will be labeled with same symbols and repeated explanations will be appropriately omitted.

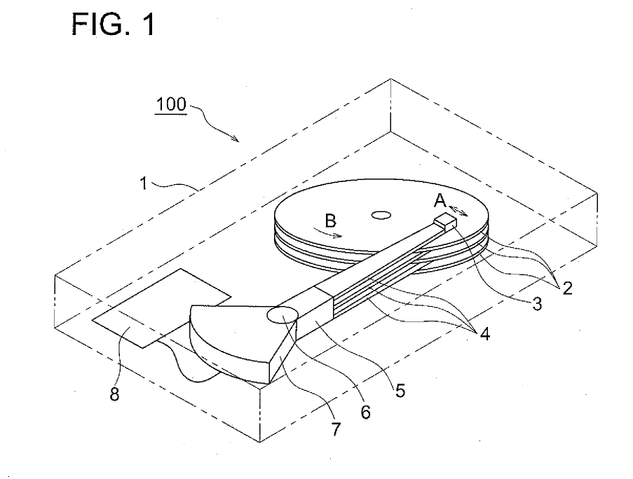

In FIG. 1, an outline constitution of an optical recording apparatus (such as a hard disc apparatus) mounted with an optically assisted magnetic recording head in an embodiment of this invention is shown. This optical recording apparatus 100 is equipped with following (1)-(6) in case 1.

(1) Disc for recording (recording medium) 2

(2) Suspension 4 supported by arm 5 which is arranged to be rotatable toward the direction of arrow head A (the tracking direction) making support axis 6 as the fulcrum

(3) Actuator for tracking 7 attached on arm 5

(4) Optically assisted magnetic recording head (hereinafter referred to as optical recording head 3) attached on the top of suspension 4 via coupling member 4a

(5) Motor (not shown in the drawing) to rotate disc 2 toward the direction of arrow head B

(6) Control part 8 to perform control of actuator for tracking 7, motor and optical recording head 3 such as irradiation of light and generation of magnetic field depending on writing information for recording on disc 2

In optical recording apparatus 100, provided is a constitution so as to relatively shift optical recording head 3 while floating on disc 2.

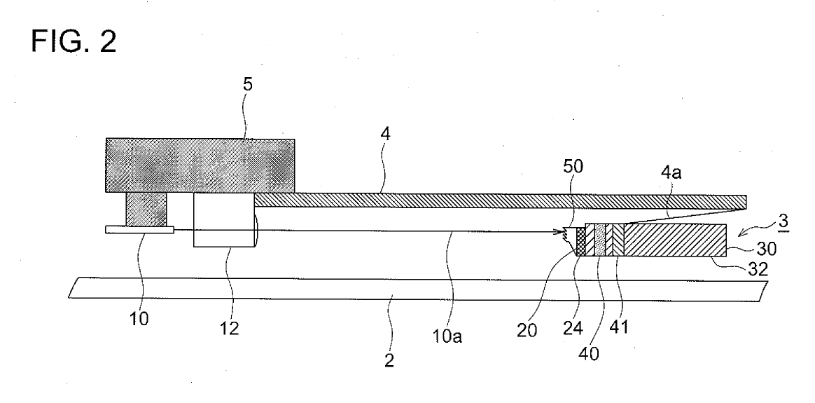

FIG. 2 conceptually shows the side view of a constitution of optical recording head 3. Optical recording head 3 utilizes light for information recording onto disc 2 and equipped with slider 30, light propagation element 20, magnetic recording part 40, magnetic reproduction part 41 and prism 50. As light propagation element 20, the aforesaid PSIM is utilized.

Slider 30 shifts relatively against disc 2, which is a magnetic recording medium, while floating, and there is a possibility of contacting with disc 2 in the case that there is dust adhering to disc 2 or defects on disc 2. To decrease abrasion caused in such a case, it is desirable to utilize a hard material having a high abrasion resistance as a material of a slider. For example, ceramic materials containing Al₂O₃; and such as AlTiC, zirconia and TiN may be utilized. Further, as an anti-abrasion treatment, the surface on the disc 2 side of slider 30 may be subjected to a surface treatment to increase abrasion resistance. For example, when a DLC (Diamond Like Carbon) cover layer is provided, light transmittance is high as well as hardness of not less than Hv=3,000 next to diamond can be obtained.

Further, the surface of slider 30 opposing to disc 2 is provided with air bearing surface 32 (also referred to as an ABS (Air Bearing Surface)) to improve floating characteristics.

Since floating of slider 30 is required to be stabilized in a state of being close to disc 2, it is necessary to appropriately apply slider 30 with pressure to restrain the floating force. Therefore, suspension 4 supporting slider 30 is provided with a function to appropriately apply pressure to restrain floating force of slider 30 in addition to a function to perform tracking of optical recording head 3.

Light source 10 is fixed on arm 5 together with lens 12 comprising plural sheets of lenses to make the light emitted from light source 10 to parallel light, at the emission top of optical fiber. Herein, such as a laser element which emits parallel light may be utilized as a light source.

In optical recording head 3, slider 30 has an approximately rectangular solid form, light propagation element 20 being provided on the side surface of slider 30 which is approximately vertical against the recording surface of disc 2 and opposes to light source 10, and prism 50 is fixed on light propagation element 20 in a pile. That is, prism 50 is arranged so as to opposes to the side surface of slider 30 provided with light propagation element 20.

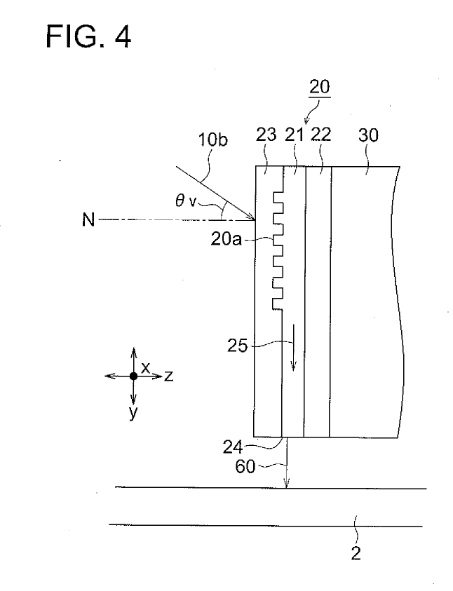

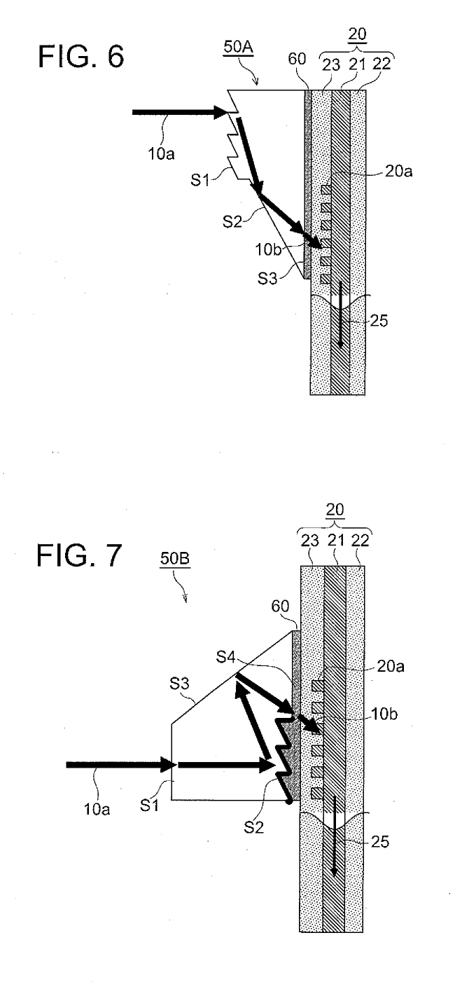

Light 10a is incident into prism 50 from lens 12 and the incident light is deflected by prism 50 with a predetermined angle which enables the light to be efficiently incident into light propagation element 20. The light having been deflected with a predetermined angle is incident into light propagation element 20 as light 10b (confer FIG. 4 and FIG. 6) emitted from prism 50 to be coupled to light propagation element 20. The light having been coupled to light propagation element 20 proceeds to the bottom surface 24 of light propagation element 20 to be irradiated toward disc 2 as irradiation light for heating disc 2.

When radiation light from the bottom surface 24 is irradiated on disc 2 as a minute light spot, the temperature of the irradiated part of disc 2 temporarily rises to lower coercive force of disc 2. Magnetic information is written from magnetic recording part 40 against the part in a state of lowered coercive force. Further, magnetic reproduction part 41, which reads out magnetic information having been written on disc 2, is provided immediately after magnetic recording part 40, however, may be provided immediately before light propagation element 20.

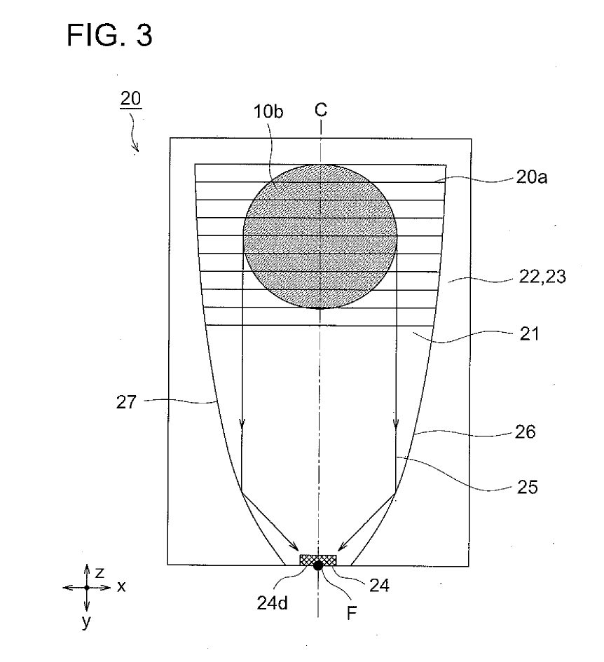

With respect to light propagation element 20, the front view and the cross-sectional view at axis C of FIG. 3 are schematically shown in FIG. 3 and in FIG. 4, respectively. Light propagation element 20 is provided with core layer 21, under cladding layer 22 and upper cladding layer 23, which constitute a waveguide; and diffraction grating 20a into which light 106 from prism 50 is incident is formed on core layer 21. In FIG. 4, light 10b is incident with a predetermined angle θv against normal line N perpendicular to the diffraction surface of diffraction grating 20a. Herein, incident angle θv to the diffraction surface of diffraction grating 20a is shown assuming the refractive index of upper cladding layer 23 to be same with that of air for simplicity. In FIG. 3, light 10b is shown as a light spot. A waveguide can be constituted of plural layers comprising substances having different refractive indexes and the refractive index of core layer 21 is not smaller than those of under cladding layer 22 and of upper cladding layer 23. A waveguide is constituted due to this difference in refractive index, and light in core layer 21 is shielded within core layer 21 to efficiently proceed toward the direction of arrow head 25 and to reach the bottom surface 24.

It is preferable to set the refractive index of core layer 21 to approximately 1.45-4.0 and the refractive indexes of under cladding layer 22 and upper cladding layer 23 to approximately 1.0-2.0.

Core layer 21 may be formed of such as Ta₂O₅, TiO₂ or ZnSe, and the thickness may be in a range of approximately from 200 nm to 500 nm, while under cladding layer 22 and upper cladding layer 23 may be formed of such as SiO₂, air or Al₂O₃ and the thickness may be in a range of approximately from 200 nm to 2,000 nm.

Core layer 21 is provided with side surfaces 26 and 27 having a parabolic outline form of the outer surface which is formed so as to reflect light having been coupled by diffraction grating 20a toward focus F to be condensed on focus F. In FIG. 3, the center axis of horizontal symmetry of a parabola is shown by axis C (a line vertical to the directrix (not shown in the drawing) and passing through focus F), and the focus of a parabola is shown as focus F. Side surfaces 26 and 27 may be provided with a reflection substance such as gold, silver or aluminum to assist decreasing the light reflection loss.

Further, bottom surface 24 of core layer 21 in a waveguide has a plane form looks like the top of a parabola being cut. Since light 60 irradiated from focus F rapidly expands, it is preferable that focus F can be arranged nearer to disc 2 by making the plane form of bottom surface 24, and in addition to this, focus F may be formed on bottom surface 24.

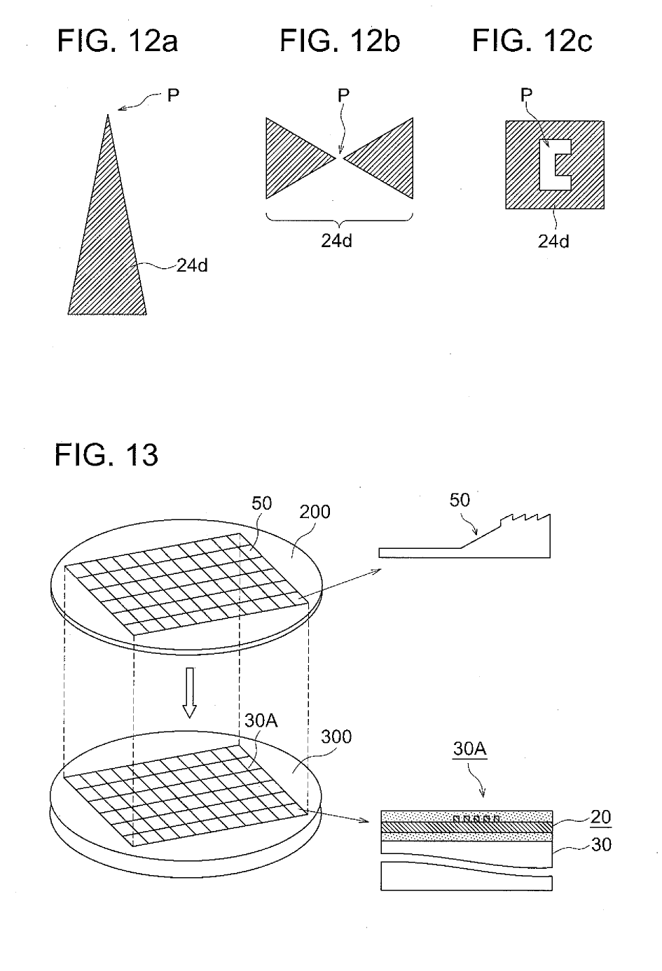

On focus F of core layer 21 or in the vicinity, plasmon antenna 24d for generation of evanescent field light is arranged. A specific example of a form of plasmon antenna 24d is shown in FIG. 12.

In FIG. 12, (a) is plasmon antenna 24d formed of a metallic thin layer (material examples: such as aluminum, gold and silver) having a triangle plane form, (b) is plasmon antenna 24d formed of a metallic thin layer (material examples: such as aluminum, gold and silver) having a bar tie form, and both are constituted of an antenna provided with top point P having radius of curvature of not more than 20 nm. Further, (c) is plasmon antenna 24d formed of a metallic thin layer (material examples: such as aluminum, gold and silver) having a plane form provided with an opening and is constituted of an antenna provided with top point P having a radius of curvature of not more than 20 nm.

When light acts on these plasmon antennas 24d, evanescent field light is generated in the neighborhood of top point P thereof to enable recording or reproduction utilizing light having a very small spot size. That is, when local plasmon is generated by arranging plasmon antenna 24d on focus F or in the vicinity, it is possible to make the size of a light spot formed on the focus smaller, which is advantageous for high density recording. Herein, top point P of plasmon antenna 24d is preferably positioned on focus F.

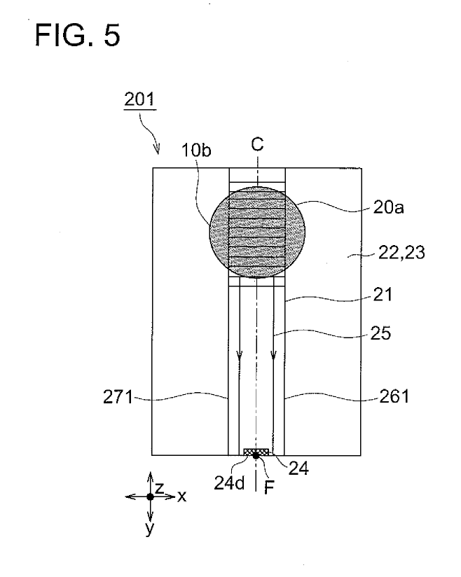

Light propagation element 20 shown in FIG. 3 is provided with a function to condense light having been coupled by diffraction grating 20a toward focus F, however, is not necessarily provided with a function to condense light propagating through a light propagation element. In FIG. 5, an example of such a light propagation element is shown. In light propagation element 201 shown in FIG. 5, core layer 21 is provided with side surfaces 261 and 271 of a straight line, which guides light coupled by diffraction grating 20a straight toward the neighborhood of focus F, in stead of side surfaces 26 and 27 in the case of the outline form of the circumference surface of light propagation element 20 in FIG. 3 being a parabola. Herein, the cross-sectional view at axis C in FIG. 5 is identical with FIG. 4.

Prism 50 will now be explained. The prisms fixed on light propagation element 20 are generically shown by symbol 50, and they are shown as prisms 50A, 50B, 50C and 50D by further attaching other symbols in the case of showing specific examples of prism 50 (confer FIGS. 6-9).

Prism 50 can be formed, for example, by an injection molding method or a press molding method utilizing thermoplastic resin as a material. Thermoplastic resin includes such as Zeonex (registered trade mark) 480R (refractive index of 1.525, manufactured by Zeon Corp.), PMMA (polymethylmethacrylate, for example, Sumipex (registered trade mark) MGSS, refractive index of 1.49, manufactured, by Sumitomo Chemical Co., Ltd.) and PC (polycarbonate, for example, Panlite (registered trade mark) AD5503, refractive index of 1.585, manufactured by Teijin Chemicals Ltd.). Further, prism 50 can be also formed by a press molding method utilizing a glass material.

By forming prism 50 utilizing a resin material, it is possible to easily form a diffraction grating, which will be described later, on the prism, in addition to form it to be light-weighted. Further, it is possible to easily manufacture prism alley substrate 200 comprising a plural number of prisms 50 in a substrate form, which is prepared to fix prism 50 on light propagation element 20 (confer FIG. 13).

FIG. 6 is a drawing to show prism 50A which is the first specific example of prism 50. Prism 50A is provided with a diffraction grating (a transparent type diffraction grating) on surface S1 into which light 10a having been emitted from lens 12 is incident, and the light diffracted is reflected on surface S2 to be emitted from surface S3. Light 10b emitted from surface S3 is incident into diffraction grating 20a with a predetermined angle taking the refractive index of adhesive 60 in consideration, and is coupled to core layer 21 to be propagated downward (in the direction of arrow head 25) of the drawing.

Prism 50A is fixed on light propagation element 20 with adhesive 60 at a position to enable efficient coupling of light 10b emitted from prism 50A to light propagation element 20.

As adhesive 60, adhesives for optical parts of such as an acryl type or an epoxy type well known in the art having a refractive index of approximately 1.3-1.5 are preferred. By utilizing such adhesive 60, it is possible to restrain lowering of transmission efficiency of light due to refractive index difference.

In this embodiment, prism 50A is fixed as one body on light propagation element 20 which is arranged on the side surface of slider 30. Therefore, prism 50 is never affected by the stress due to a bend caused in suspension 4 such as explained in the reference example. As a result, variation in optical characteristics such as polarization rotation is never generated to enable generation of evanescent light stably at the light emitting edge of light propagation element 20.

Further, it is possible to easily perform position adjustment between light propagation element 20 and prism 50 to enable easy assembly of an apparatus.

Furthermore, during operation of optical recording head 3, since the positioning relation of prism 50 and light propagation element 20 never changes not to affect on the light propagation efficiency, whereby higher stability is achieved.

The light incident into diffraction grating 20a of light propagation element 20 is possibly decreases coupling efficiency to core layer 21 by being affected with dust and flows on the surface of upper cladding layer 23. In this embodiment, by arranging prism 50 on light propagation element 20 in a pile, since the surface of upper cladding layer 23, especially the surface at the position opposing to diffraction grating 20a, is covered to be protected, light incident into diffraction grating 20a is not affected by dust or flows to enable prevention of decrease of the coupling efficiency.

In the case of prism 50 fixed on light propagation element 20 being provided with a diffraction grating, such as surface S1 of prism 50A, an effect of wavelength variation due to a mode hop phenomenon, which generates when semiconductor laser is utilized as a light source, can be relieved. That is, depending on variation of a range of the incident angle of light suitable for diffraction grating 20a of light propagation element 20, the incident angle against light propagation element 20 can be adjusted by a diffraction grating provided on prism 50, whereby of utilizing efficiency of light can be increased.

When a period of a grating varies due to an effect of thermal expansion of a substrate on which a diffraction grating is formed, the diffraction angle will vary to possibly cause a case that essential abilities of diffraction grating cannot be exhibited.

In the case of prism 50 fixed on light propagation element 20 is provided with a diffraction grating, it is preferable that this diffraction grating is arranged parallel to the surface where prism 50 is fixed on slider 30 (via light propagation element 20) to lighten the effect of thermal expansion of the above-described substrate. With respect to this point, explanation will be made utilizing an analytical result by simulation.

FIG. 10 shows the result of analysis of a prism form by a two-dimensional finite element method. Member 501 simulating a prism had thickness t of 0.24 mm and height h of 1.24 mm and the material was polycarbonate. The material of member 301 simulating a slider is preferably a ceramic material having a thermal expansion coefficient not larger than that of a resin material and utilized was AlTiC as an example. The characteristics such as thermal expansion coefficient of an adhesive for fixing member 501 and member 301 are set to be same as those of polycarbonate. Herein, in this embodiment, light propagation element 20 is present between prism 50 and slider 30; however, it is omitted because there is little influence on the simulation analysis result because light propagation element 20 has a thickness of approximately a few μm.

As shown in FIG. 10, a change of the form of member 501 between the case of the temperature of member 501 and member 301 being 25° C. and in the case of the temperature being raised to 70° C. were obtained by simulation. The broken line of FIG. 10 shows the form at 25° C. and the solid line shows the form at 70° C. Herein, in FIG. 10, the form change of member 501 is shown largely deformed and no change is shown as for member 301 since it exhibits very small thermal expansion.

In FIG. 10, variation quantity Δt in the thickness direction was 0.297% based on a variation ratio, and variation quantity Δh in the height direction was 0.227% based on a variation ratio. From this result, it is clear that surface 501b is more preferred than surface 501a when a diffraction grating is provided on member 501. Surface S1 of prism 50A shown in FIG. 6 corresponds to this surface 501b.

Further, a variation ratio of surface 501c adhered with member 301 is not more than 0.01% and it is clear that to arrange a diffraction grating on this surface 501c is also more desirable than to arrange it on surface 501a. Surface S2 of prism 50B shown in FIG. 7 corresponds to this surface 501c.

FIG. 7 is a drawing to show prism 50B which is the second specific example of prism 50.

In prism 50B shown in FIG. 7, light 10a emitted from lens 12 is incident on surface S1 to be diffracted by a diffraction grating (a reflection type diffraction grating) provided on surface S2, and the light diffracted is reflected by surface S3 to be emitted from surface S4. Light 10b emitted from surface S4 is incident into diffraction grating 20a with a predetermined angle taking the refractive index of adhesive 60 in consideration, being coupled to core layer 21 to be propagated downward (in the direction of arrow head 25) in the drawing.

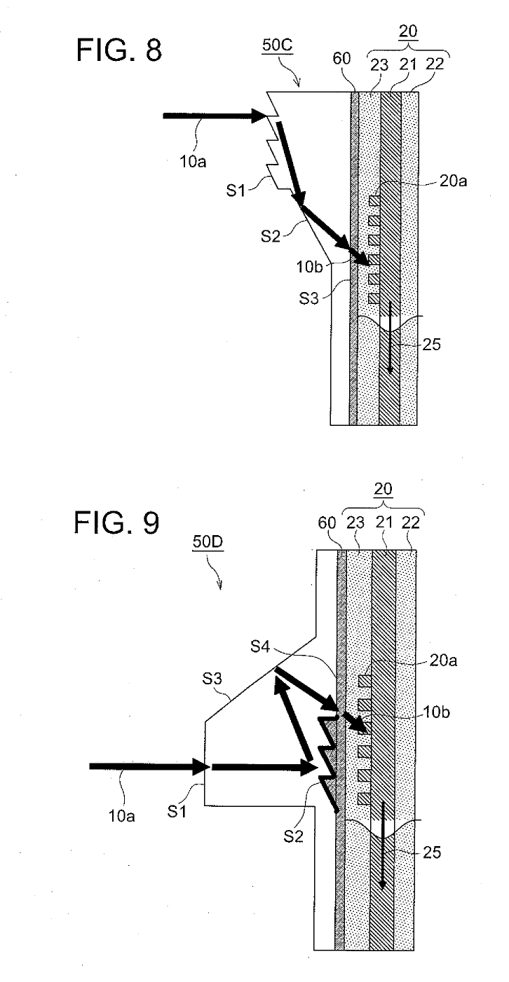

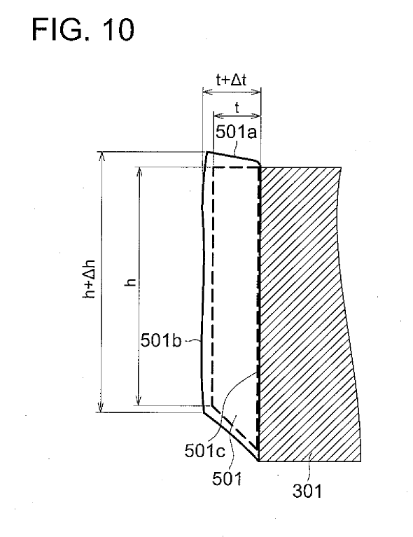

In prisms 50A and 50B shown in FIGS. 6 and 7, shown is an example in which prism 50 covers a part of cladding layer 23 on light propagation element 20; however, possible is the form of prism 50 covering the whole of cladding layer 23 on light propagation element 20 as prism 50C and 50D which are the third and fourth specific examples shown in FIGS. 8 and 9. Herein, prism 50C in FIG. 8 guides light similarly to prism 50A in FIG. 6, and prism 50D in FIG. 9 guides light similarly to prism 50B in FIG. 7.

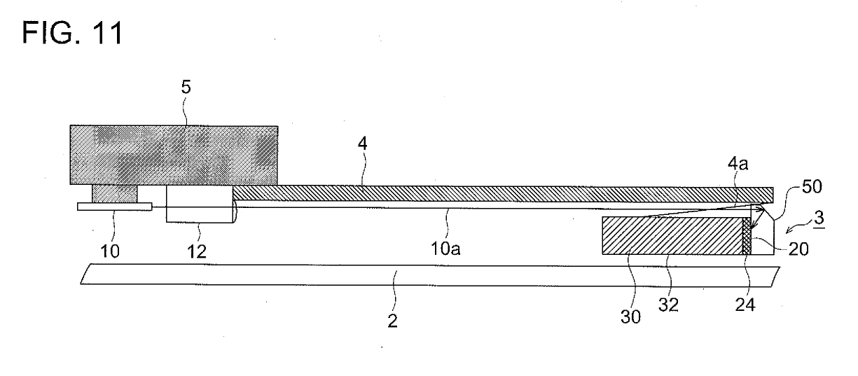

Further, in FIG. 2, light propagation element 20 and prism 50 are arranged on the side surface opposing to light source 10 of slider 30; however, the position of them are not limited thereto and they may be arranged on the opposite side surface to light source 10 as shown in FIG. 11. In this case, the constitution makes light 10a from light source be turned back by prism 50 to be incident into light propagation element 20. Herein, in FIG. 11, a diffraction grating of prism 50, a magnetic recording part and a magnetic reproduction part are not shown in the drawing.

In the following, manufacturing of optical recording head 3 in which prism 50 is fixed in a piled on light propagation element 20 will be explained.

Optical recording head 3 can be formed, for example, by a method in which materials to form magnetic reproduction part 41, SiO2 layer, magnetic recording part 40, under cladding layer 22, core layer 21 and upper cladding layer 23 are accumulated in order on a substrate (material: such as AlTiC) and each layer is appropriately made into a desired form by a general semiconductor process such as an electron beam lithography or a photolithographic technique after each layer having been formed.

A substrate formed in a state of plural pieces of slider 30 which constitutes one body with magnetic recording part 40, magnetic reproduction part 41 and light propagation element 20 being arranged in a row (hereinafter, referred to as a slider substrate), which are formed in the above manner, is cut out vertically against the substrate surface, whereby slider 30 equipped with as plural pieces of such as light propagation elements 20 can be prepared. Hereinafter, slider 30 which constitutes one body together with magnetic recording part 40, magnetic reproduction part 41 and light propagation element 20, is hereinafter referred to as slider 30A.

In the case of assembling prism 50 on slider 30A manufactured in such a manner, possible is a procedure to paste prism 50 on light propagation element 20 by use of such as an adhesive after slider 30A is individually separated from a slider substrate. In this case, the handling is not easy since the size is very small, and there is a possibility of making assembly work complicated when the number of pieces is large.

A more preferable manufacturing method to solve this problem will be explained in reference to FIG. 13.

(1) Prism alley substrate 200 in which plural pieces of prisms 50 corresponding to the positions and the number of plural pieces of sliders 30A produced on slider substrate 300 are formed in a substrate state is manufactured.

(2) Prism alley substrate 200 and slider substrate 300 are joined by use of such as an adhesive so as to make the position of slider 30A and that of prism 50 coincide.

(3) After joining, prism 50 and slider 30 having been joined in one body are individually separated.

By manufacturing in this manner, an optical recording head in a state of prism 50 being fixed on slider 30A can be easily manufactured and the handling thereof also becomes easy.

In the case of manufacturing according to the above-described method, it is preferable to make a state so that prism 50 covers the whole of upper cladding layer 23 on light propagation element 20 as shown in FIGS. 8 and 9, for manufacturing of prism alley substrate 200.

By fixing prism 50 on the side surface of slider 30 equipped with light propagation element 20, as described above, an efficient manufacturing method, in which individual cut out is performed after a substrate on which plural pieces of the both having been piled and adhered, can be applied, and in addition, there is a merit of not disturbing preparation of a thinner optical recording head because the height of slider 30 also shows no difference from the case of not providing prism 50.

The embodiment explained above is related to an optically assisted magnetic recording head and an optical recording apparatus equipped with the same; however, is also possible to be applied to an optical recording head and an optical recording apparatus equipped with the same utilizing an optical recording disc as a recording medium. In this case, magnetic recording part 40 and magnetic reproduction part 41 are unnecessary.

According to the embodiment explained above, since light can be deflected with a predetermined angle so as to be efficiently incident into light propagation element 20 by prism 50, it is possible to improve utilization efficiency of light.

### DESCRIPTION OF NUMERIC DESIGNATIONS

1: Case
2: Disk
3: Optical recording head
4: Suspension
5: Arm
10: Light source
10a, 10b: Light
12: Lens
20, 201: Light propagation element
21: Core layer
22: Under cladding layer
23: Upper cladding layer
24: Bottom surface
24d: Plasmon antenna
26, 27: Side surface
20a: Diffraction grating
30: Slider
32: Air bearing surface
40: Magnetic recording part
41: Magnetic reproduction part
50, 50A, 50B, 50C, 50D: Prism
100: Optical recording apparatus
C: Axis
F: Focus

1. An optical recording head to record information onto a recording medium utilizing light comprising:
a slider provided to move relatively to the recording medium;
a light propagation element provided on a side surface of the slider substantially vertical against a recording surface of the recording medium so as to cause propagation of light incident with a predetermined angle to be irradiated on the recording medium; and,
a prism provided on the light propagation element so as to oppose to the side surface of the slider having the light propagation element and to deflect the incident light to be incident into the light propagation element with a predetermined angle.

2. The optical recording head of claim 1,
wherein the light propagation element further comprising,
a waveguide to propagate light; and
a diffraction grating to cause optical coupling of a light incident with a predetermined angle onto the waveguide.

3. The optical recording head of claim 2,
wherein the waveguide is provided with a function to converge a propagating light.

4. The optical recording head of claim 1
wherein the prism is provided with a diffraction grating, and,
the diffraction grating is provided parallel to the side surface of the slider on which the prism is provided via the light propagation element.

5. The optical recording head of claim 4,
wherein a thermal expansion coefficient of a material constituting the slider is smaller than a thermal expansion coefficient of a material constituting the prism.

6. The optical recording head of claim 5,
wherein a material of the slider is ceramic and a material of the prism is resin.

7. The optical recording head of claim 1,
wherein the prism is provided so as to cover a whole surface on which the light from the light propagation element is incident.

8. An optical recording apparatus comprising:
the optical recording head of claim 1;
a light source to emit light to be incident onto the prism; and,
a recording medium on which information is recorded utilizing light from the light propagation element.

9. The optical recording apparatus of claim 8,
wherein the recording medium is a magnetic recording medium; and,
the optical recording head is provided with a magnetic recording part to perform magnetic recording on the magnetic recording medium.

10. The optical recording apparatus of claim 8;
the light propagation element and the prism are provided onto a side surface of the slider which opposes to the light source.
